(19) United States
(12) Patent Application Publication
(10) Pub. No.: US 2017/0350466 A1
(43) Pub. Date: Dec. 7, 2017

(54) SHOCK ABSORBER

(71) Applicant: SUSPA GmbH, Altdorf (DE)

(72) Inventors: Andreas BÖHRER, Neumarkt (DE); Florian STEPHAN, Herzogenaurach (DE)

(21) Appl. No.: 15/607,971

(22) Filed: May 30, 2017

(30) Foreign Application Priority Data
Jun. 3, 2016 (DE) 10 2016 209 824.1

(51) Int. Cl. F16F 9/44; F16F 9/06; F16F 9/46; F16F 9/19; F16F 7/09

(52) U.S. Cl. CPC F16F 9/44; F16F 9/062; F16F 9/468; F16F 7/09; F16F 9/19

(57) ABSTRACT

A shock absorber comprises a housing having a work space, damping fluid present in the work space, a piston unit arranged in the work space with a piston rod having a longitudinal axis, a piston secured to the piston rod, dividing the work space into a first partial work space and a second partial work space, a flow channel connecting the first partial work space and the second partial work space, an adjustment unit for adjusting the damping force of the shock absorber with an adjustment element for adjusting the effective flow cross section area of the flow channel, an adjustment actuator for the automated adjusting of an arrangement of the adjustment element and the piston rod, wherein the adjustment unit is arranged inside the shock absorber.

### CROSS-REFERENCES TO RELATED APPLICATIONS

This application claims the priority of German Patent Application, Serial No. 10 2016 209 824.1, filed Jun. 3, 2016, pursuant to 35 U.S.C. 119(a)-(d), the content of which is incorporated herein by reference in its entirety as if fully set forth herein.

### FIELD OF THE INVENTION

The invention concerns a shock absorber.

### BACKGROUND OF THE INVENTION

A shock absorber is known from DE 10 2010 029 180 A1.

### SUMMARY OF THE INVENTION

The problem which the present invention proposes to solve is to improve a shock absorber so that its damping action can be adjusted in an uncomplicated, especially an automated, and robust manner.

This problem is solved according to the invention by a shock absorber comprising a housing having a work space, damping fluid present in the work space, a piston unit arranged in the work space with a piston rod having a longitudinal axis, a piston secured to the piston rod, dividing the work space into a first partial work space and a second partial work space and a flow channel connecting the first partial work space and the second partial work space, and an adjustment unit for adjusting the damping force of the shock absorber with an adjustment element for adjusting the effective flow cross section area of the flow channel and an adjustment actuator for the automated adjusting of an arrangement of the adjustment element and the piston rod, wherein the adjustment unit is arranged inside the shock absorber.

According to the invention, it has been discovered that an adjustment unit for adjusting a damping force of a shock absorber is arranged inside the shock absorber. The adjustment unit in particular is arranged in a housing of the shock absorber. Such a shock absorber has an especially compact form. The shock absorber, especially the adjustment unit, has an enhanced functional integration. The shock absorber according to the invention can be used, for example, to move a vehicle seat, especially a seat in a lorry or in a passenger car. A separate electromechanical coupling of the shock absorber to an externally arranged adjustment unit is unnecessary. This results in a reduced footprint. Force transmission elements situated outside the shock absorber between the adjustment unit and the shock absorber are unnecessary. The housing comprises a work space in which damping fluid is present. In the work space there is arranged a piston unit with a piston rod having a longitudinal axis, and a piston secured to the piston rod, dividing the work space into a first partial work space and a second partial work space. The adjustment unit can also be arranged inside the piston rod. A displacement of the piston rod along the longitudinal axis relative to the housing can result in the adjustment unit situated inside the piston rod being arranged outside the housing at least for a portion and/or at least temporarily. Such an arrangement of the adjustment unit is to be understood as being inside the shock absorber in the sense of the invention.

The first partial work space and the second partial work space are interconnected by a flow channel. The adjustment unit comprises an adjustment element, with which an effective flow cross section area of the flow channel can be adjusted. For an automated adjustment, an adjustment actuator is used that adjusts an arrangement of the adjustment element and the piston rod. The shock absorber according to the invention has the advantage, in particular compared to a shock absorber governed by a magnetic valve, of a simplified, uncomplicated design. The shock absorber according to the invention is compact and space-saving and resistant to failure. The shock absorber according to the invention enables an adjustment within a time interval of less than 1 second, especially less than 500 ms, particularly less than 300 ms. Another major advantage of the shock absorber according to the invention is that a permanent energization, i.e., a permanent electrical power supply, is not necessary.

A control, which stands in signal communication with the adjustment unit for the specific adjusting of the effective flow cross section area of the flow channel, simplifies the automated adjusting of the damping force. In particular, it is possible by means of a specific control signal which is transmitted from the control unit to the adjustment unit to accomplish a specific adjusting of the adjustment element in relation to the piston rod.

An adjustability, in which the adjustment element and the piston rod are rotatable relative to each other in regard to the longitudinal axis, enables an advantageous direct adjusting of the flow cross section area of the flow channel.

An embodiment of the shock absorber, in which the adjustment element is rotatable in regard to the longitudinal axis, enables an uncomplicated design. In particular, the adjustment element is arranged rotatable in the piston rod. The adjustment element in particular can be driven in rotation with regard to the piston rod and especially in regard to the housing.

The embodiment of the adjustment element, in which the adjustment element is designed as a shaft shoulder, which has a step, in particular multiple steps, along the longitudinal axis, wherein at least one step of the shaft shoulder has a non-round cross section area oriented perpendicular to the longitudinal axis, enables a specific, in particular a stepwise covering of a plurality of through-openings which form the flow channel. Stepwise means the shaft shoulder has different lengths in a direction parallel to the longitudinal axis, so that flow openings which are formed in a lateral wall of the piston rod are covered or opened up, depending on the relative rotary position of the adjustment element with respect to the piston rod.

The embodiment of the shock absorber, in which the adjustment element is axially movable with regard to the longitudinal axis, enables an uncomplicated design of the adjustment element. The damping action is adjusted by means of an axial displacement of the adjustment element. By means of a kinematic device, in particular a rotary drive movement of the adjustment actuator is converted into an axial displacement of the adjustment element. The adjustment element in particular can move relative to the piston rod, especially under driving action.

Advantageous embodiments of the adjustment element, in which the adjustment element is designed as a spindle nut or in which the adjustment unit is designed as a needle valve, enable an uncomplicated implementing of the axial adjustability of the adjustment element.

The integrated arrangement, in which the adjustment unit is arranged integrated in the piston rod, is especially space-saving. In particular, it has been discovered that the piston rod can be effectively utilized in that a volume situated therein can be utilized as structural space for the adjustment unit. In particular, it is not necessary to create additional structural space inside or outside the shock absorber in order to accommodate the adjustment unit. In this embodiment, a design of a shock absorber with enhanced functionality and the same structural size is possible.

A shock absorber, in which the piston rod is tubular in design, enables an effective integration of the adjustment unit. Tubular means that the piston rod is hollow. It is advantageous for the outer contour of the piston rod to be circular. It is advantageous for the inner contour of the piston rod to be circular. In particular, the inner contour can also have a different shape, which in particular is non-round with respect to the longitudinal axis.

A position recognition unit, which stands in signal communication in particular with the adjustment unit, especially with the adjustment actuator, simplifies the adjustment of the damping action, especially given a separation of the shock absorber from the power supply. The position recognition unit stands in signal communication in particular with the adjustment unit. The position recognition unit stands in signal communication in particular with the control unit.

A reference element for defining a reference position of the adjustment element simplifies the immediate position recognition, especially by means of an encoder. The reference element for example may be a reference mark or a multiturn encoder. In particular, the reference element is designed as a mechanical reference, especially as an end stop element. When the adjustment element comes up against the reference element, this results in a significant rise in the motor current of the adjustment actuator. The control unit can detect this significant rise in the motor current as the reaching of the reference element.

A shock absorber, in which the adjustment actuator is designed as a rotary drive, especially an electric motor, enables an uncomplicated providing of an adjustment actuator.

A sealing element for sealing off a cavity of the piston rod ensures that damping fluid does not escape unintentionally from the work space of the shock absorber across the piston rod. The sealing element is designed, for example, as an O-ring and it seals the adjustment unit radially at an inner cylinder surface of the piston rod. The position of the sealing element along the longitudinal axis can be established in various ways. For example, it is conceivable to seal the adjustment element in the piston rod. The adjustment element in particular is arranged facing the work space of the shock absorber. It is also possible to place the sealing element on a top side of the adjustment actuator facing away from the work space. In such an embodiment, in particular the adjustment element and the adjustment actuator are surrounded by the damping fluid, especially damping oil.

Further advantageous embodiments, additional features and details of the invention will emerge from the following description of exemplary embodiments with the aid of the drawing.

### BRIEF DESCRIPTION OF THE DRAWING

FIG. 1 shows a perspective representation of a longitudinal section through a shock absorber according to a first exemplary embodiment,

FIG. 2 shows an enlarged partial view of a first arrangement of an adjustment unit per FIG. 1,

FIG. 3 shows a view corresponding to FIG. 2 in a second arrangement of the adjustment unit,

FIG. 4 shows a longitudinal section through a piston rod with integrated adjustment unit of a shock absorber according to a second exemplary embodiment in a first arrangement,

FIG. 5 shows a representation corresponding to FIG. 4 with the adjustment unit in a second arrangement,

FIG. 6 shows a schematic representation of an adjustment kinematics according to a third exemplary embodiment.

### DESCRIPTION OF THE PREFERRED EMBODIMENTS

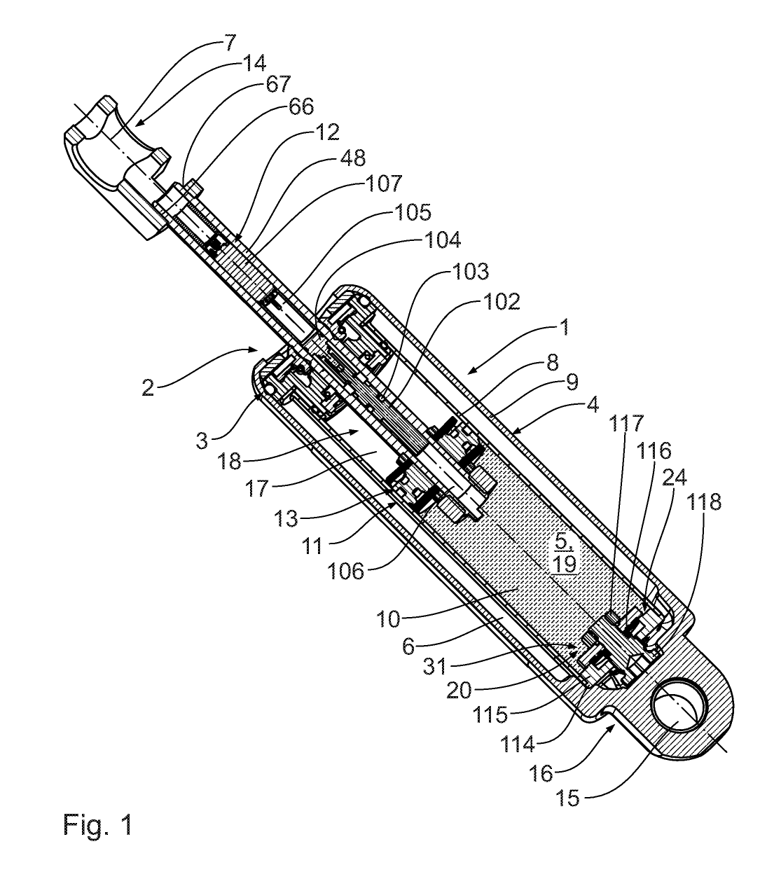

A shock absorber 1 shown in FIGS. 1 to 3 is a fluid shock absorber. The design and function of such a fluid shock absorber are known from DE 10 2010 029 180 A1, to which reference is made here.

The shock absorber 1 comprises a housing 4 with a first housing end 2 and a second housing end 16. The housing 4 is closed at the first housing end 2 by a guiding and sealing unit 3. At the second housing end 16 the housing 4 comprises a second fastening element 15. The housing 4 encloses a work space 5 and an equalizing space 6. The housing 4 has a longitudinal axis 7. In particular, it is configured rotationally symmetrical to the longitudinal axis 7 at least for a portion. The housing 4 may be of double-wall design. In particular, it comprises an inner housing 8 and an outer housing 9. The outer housing 9 surrounds the inner housing 8. The outer housing 9 in particular can be arranged concentrically to the inner housing 8. Thus, the equalizing space 6 is formed as an annular cylindrical cavity.

In an alternative variant, not represented in the figures, the outer housing 9 may also be arranged offset from the inner housing 8, so that the equalizing space 6 has a variable, that is, a nonconstant width along its circumference. In this case, the equalizing space 6 can be designed topologically contractibly, in particular.

The work space 5 is filled with a damping fluid 10. The damping fluid 10 is in particular a hydraulic oil. The equalizing space 6 is partly filled with the damping fluid 10. The rest of the equalizing space 6 is filled with gas, especially air.

The guiding and sealing unit 3 comprises a first seal element 41, which lies tightly against the piston rod 12. For its securing on the piston rod 12, the first seal element 41 has an annular groove 42, in which a clamping ring 43 is arranged. Furthermore, the guiding and sealing unit 3 comprises a supporting element 44 braced against the outer housing 9. The supporting element 44 is tightly mounted by means of a sealing ring 45 against the outer housing 9. It has a central blind hole 46. The guiding and sealing unit 3 has a central bore 47. The bore 47 in particular is arranged concentrically to the longitudinal axis 7. The piston rod 12 is led through the bore 47.

Furthermore, the shock absorber 1 comprises a piston unit 11 with a piston rod 12 and a piston 13. The piston 13 is secured to the piston rod 12 and led movably in the inner housing 8 along the longitudinal axis 7. The piston rod 12 is led out from the housing 4, sealed by the guiding and sealing unit 3. At its end opposite the piston 13, the piston rod 12 is connected to a first fastening element 14.

The piston 13 divides the work space 5 into a first partial work space 17 facing the first housing end 2 with a first work space end 18 and a second partial work space 19 facing the second housing end 16 with a second work space end 20.

At the first work space end 18 there is arranged a first closing element 21. The first closing element 21 is arranged in the inner housing 8. The first closing element 21 can be inserted in particular into the inner housing 8, preferably by press fit or by screwing. It is sealed off against the inner housing 8 by means of a sealing ring 22. The first closing element 21 is fashioned as a single piece with the supporting element 44. Thus, it is likewise a component of the guiding and sealing unit 3. In principle, however, it is also conceivable to design the first closing element 21 and the supporting element 44 as separate parts. For further details regarding embodiments of the first closing element 21, refer to DE 10 2005 023 756 A1.

The first closing element comprises a first equalizing channel, which forms a flow connection between the first partial work space 17 and the equalizing space 6.

At the second work space end 20 there is arranged a second closing element 24. The second closing element 24 is arranged in the inner housing 8. The second closing element 24 can in particular be inserted into the inner housing 8, preferably by press fit. Furthermore, the inner housing 8 can lie against the outer housing 9 in regions at its circumference in the region of the second work space end 20.

The second closing element 24 comprises a second equalizing channel, which forms a flow connection between the second partial work space 19 and the equalizing space 6.

The second closing element 24 is axially braced by a stop shoulder 114 at the end face against the inner housing 8 and radially braced by an insertion collar 115 against the inner cylinder envelope surface of the inner housing 8. The insertion collar 115 is radially pretensioned by means of a radial spring element 116 in regard to the longitudinal axis 7, the pretensioning being applied axially by means of a clamping nut 117 on a clamping bolt 118. The inner housing 8 is pressed radially outward against an inner side of the outer housing 9 and thereby held in the region where the insertion collar 115 lies against the inner cylinder envelope surface of the inner housing 8.

For a proper functioning of the shock absorber 1, the work space 5 should always be entirely filled with damping fluid 10. This can be achieved by a suitable design and arrangement of the second equalizing channel as well as a quantity of damping fluid 10 which is adapted to the volume of the work space 5 and the configuration of the equalizing space 6. In particular, the shock absorber 1 has a preferred installation position, such that the extending direction 40 is directed opposite the force of gravity. The proper functioning of the shock absorber 1 can then be ensured up to an angle of rotation of at least 77° from the preferred installation position.

In the second equalizing channel there is provided an equalizing valve 31. Regarding the design of the equalizing valve 31, reference is made to DE 10 2010 029 180 A1 and corresponding US 2011/0284333 A1, the entire contents of which are hereby incorporated by reference.

The equalizing valve 31 is designed as a self-acting valve. It can be designed as a one-way valve. In particular, it is designed so as to allow a flow from the equalizing space 6 through the second equalizing channel into the second partial work space 19. In other words, the equalizing valve 31 is designed so that it opens upon movement of the piston 13 in an extending direction 40 parallel to the direction of the longitudinal axis 7.

In the exemplary embodiment shown in FIGS. 1 to 3, the equalizing valve 31 is designed so as to allow a bidirectional flow through the second equalizing channel. It is thus designed as a two-way valve. In particular, the equalizing valve 31 can have characteristics which allow a bidirectional flow between the second partial work space 19 and the equalizing space 6 regardless of the position of the valve disc.

In general, it is provided that the equalizing valve 31 forms an overload protection element, which ensures an open state of the second equalizing channel upon exceeding a predetermined limit force in the direction of the longitudinal axis 7 on the piston rod 12. The activation characteristic of this overload protection can be achieved in a simple manner by suitable selection and dimensioning of a valve helical spring and a valve plate spring.

An alternative design of the equalizing valve 31 is conceivable. For further details about the equalizing valve 31, refer to DE 10 2005 023 756 A1, especially paragraph [0022].

The piston rod 12 is multipart, in particular two-part. It comprises an outer, tubular shaped piston rod sleeve 48.

The piston rod sleeve 48 can be connected to the first fastening element 14. The first fastening element 14 has a snug fit 66 arranged concentrically to the longitudinal axis 7, by which the first fastening element is shoved onto an outer side of the piston rod 12, especially the piston rod sleeve 48. The first fastening element 14 is connected to the piston rod 12 by a weld 67.

The first fastening element 14 can alternatively have an internal thread, by means of which the first fastening element 14 is screwed onto a corresponding external thread on the piston rod sleeve 48.

In one end region 69, an adjustment unit 101 has an adjustment element 102 with a recess 70. The recess 70 is fashioned as a circle segment in the direction perpendicular to the longitudinal axis 7. It has a centre angle b. The centre angle is at least 15°, especially at least 30°, especially at least 45°, especially at least 60°, especially at least 90°. It can also be 120° in particular. The upper limit for the centre angle is at most 270°, especially at most 180°. In principle, a circle sector shape of the recess 70 is also possible.

The recess 70 is part of a flow channel 71, which forms a flow connection between the partial work spaces 17, 19. In addition to the recess 70, the flow channel 71 comprises several bores 72 in the piston rod sleeve 48. In other words, the bores 72 together with the recess 70 form the flow channel 71. The flow channel 71 is thus arranged in the piston rod 12.

At least one bore 72 is provided in the piston rod sleeve 48. In the exemplary embodiment shown in FIGS. 1 to 3, the piston rod sleeve 48 has three bores 72. It may also have four, five, or more bores 72. The bores 72 are offset to one another in the circumferential direction. The bores 72 all have the same size. However, bores 72 of different size are also conceivable.

Alternatively to several discrete bores 72, the piston rod sleeve 48 can also have an elongated flow opening. The flow opening extends preferably in the circumferential direction. It covers an angle range which is at most as large as the centre angle of the recess 70.

The bores 72 are selectively closable by means of the end region 69. Thus, the end region 69 forms the adjustment element 102 by means of which the effective flow cross section of the flow channel 71 can be adjusted. The adjustment element for the adjusting of the effective flow cross section of the flow channel 71 is thus arranged inside the piston rod 12, especially inside the piston rod sleeve 48.

By means of the adjustment element 102, the flow channel 71 can be closed in particular to interrupt the flow connection between the partial work spaces 17, 19. In this way, the shock absorber 1 can be blocked.

Several discrete bores 72 enable several different discrete damping settings of the shock absorber 1. The shock absorber 1 can thus have a stepwise damping characteristic. By an advantageous arrangement of the bores 72, it is possible to achieve a continuously adjustable damping behaviour of the shock absorber 1, for example by arranging the bores 72 to overlap at least partly along an activation direction of the adjustment element 102. The adjusting direction of the adjustment element 102 is oriented axially and/or tangentially to the longitudinal axis 7. Likewise, an elongated opening in the piston rod sleeve 48 enables a continuously adjustable damping behaviour of the shock absorber 1.

The adjustment element 102 is movable, especially rotatable, with respect to the piston rod sleeve 48.

The piston rod sleeve 48 has a reduced outer diameter at a first piston rod end 50 arranged in the inner housing 8, forming a piston rod end stop 51. On the piston rod sleeve 48 in the region of the first piston rod end 50 there are arranged, starting from the piston rod end stop 51, a first spacer washer 52, a first closure element 53, especially in the form of a plate spring, a piston washer 54, a second closure element 55, especially in the form of a plate spring, a second spacer washer 56 and a securing nut 57. The securing nut 57 is screwed onto a piston rod thread and secures the piston 13 on the piston rod 12. The piston 13 is formed by the first closure element 53, the piston washer 54, the second closure element 55 and a piston seal 58. The piston seal 58 is formed as a ring and arranged in an annular groove 59 in the piston washer 54. The piston seal 58 thus seals the piston washer 54 off against the inner housing 8.

Several flow channels 60 are provided in the piston washer 54. The flow channels 60 form a flow connection between the first partial work space 17 and the second partial work space 19. The closure elements 53, 55 each interact with at least one of the flow channels 60. They may also interact with several of the flow channels 60. In particular, they may act as a valve element and influence the efficient flow cross section of the flow channels 60 in dependence on a movement direction and/or movement velocity of the piston 13 in regard to the extending direction 40. In particular, they may be designed such that only a unidirectional flow through the flow channels 60 is possible. In this case, the closure elements 53, 55 form a one-way valve. The closure elements 53, 55 can also be designed in particular so as to open when a certain limit force is exceeded. In this case, they form an overload protection.

An alternative design of the piston 13 is conceivable. In this regard, as well as for further details regarding the flow channel 60 and the closure elements 53, 55, refer to the specification of DE 10 2005 023 756 A1, especially paragraph [0023] et seq. In particular, it is also possible to design the piston 13 tight, that is, without flow channels 60. In this case, the partial work spaces 17, 19 are separated in fluid-tight manner by the piston 13. The flow channel 71 in the piston rod 12 in this case forms the sole direct flow connection between the partial work spaces 17, 19.

The adjustment unit 101 serves to adjust the damping force of the shock absorber 1. The adjustment unit 101 comprises the adjustment element 102. The adjustment element 102 is designed as a stepped shaft shoulder. The adjustment element 102 for example can be designed with a non-round end region, as is known per DE 10 2010 029 180 A1. The adjustment element 102 is sealed by means of an O-ring as sealing element 103 against an inner cylinder envelope surface of the hollow piston rod 12. According to one exemplary embodiment not shown, the sealing element can also be arranged along the longitudinal axis 7 between the motor 105 and the position recognition unit 107. In this case, the motor 105, the transmission 104 and the adjustment element 102 would be exposed to the damping fluid, especially the damping oil. On the other hand, it would be sufficient to ensure the seal with respect to the position recognition unit 107 and to ensure the wiring which connects the adjustment unit 101 to a control unit.

The adjustment element 102 is coupled across a transmission 104 to an electric motor 105. The electric motor 105 provides a rotary movement, which is transmitted across the transmission 104 to the adjustment element 102. The adjustment element 102 is arranged in the cavity 106 of the piston rod 12, able to rotate with respect to the longitudinal axis 7.

The axial displacement of the adjustment element 102 is realized for example by means of an electric drive, especially by means of an electric motor. In addition or alternatively, hydraulic and/or pneumatic drives can be used to provide the axial drive movement. The implementing of the rotary drive movement can be implemented for example by means of a spindle drive. Alternatively, linear adjustment actuators can be used, such as a linear motor, an electromagnet, a pneumatic cylinder and/or a hydraulic cylinder.

At one end of the motor 105 facing away from the work space 5 there is arranged a position recognition unit 107 in the form of an encoder. The position recognition unit 107 serves to recognize the incremental relative position of the adjustment unit 101, especially the adjustment element 102.

In particular, a reference element 108 is provided. According to the exemplary embodiment shown, the reference element 108 is designed as a radial pin protruding inwardly into the cavity 106 and arranged on an inner surface of the piston rod 12. The reference element 108 is a mechanical reference end stop element for the adjustment element 102.

Instead of the radial pin 108, other reference elements can be used. For example, a reference mark can be provided, which is optically recognized, for example. The reference mark can also be magnetically designed, corresponding to the adjustment element. It is important that the angle of rotation by which the adjustment element 102 can turn about the longitudinal axis 7 is less than 360° thanks to the reference element. This enables a clear-cut coordinating of the absolute position of the adjustment element 102 through the position recognition unit 107.

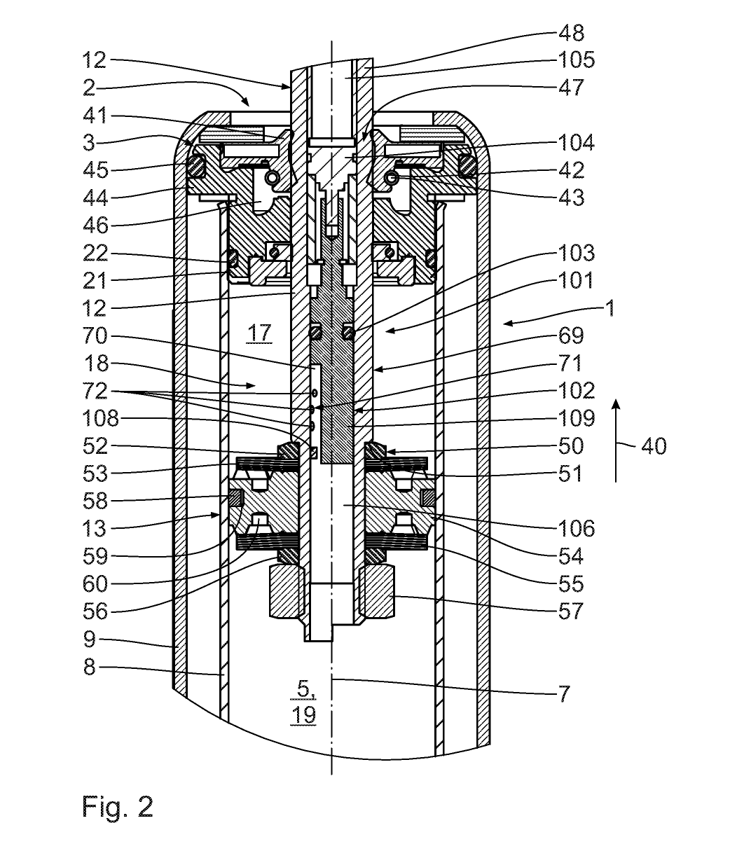

The tubular piston rod 12 has several flow openings 72 spaced apart from each other. The flow openings 72 completely pierce the cylinder envelope wall of the piston rod 12. The flow openings 72 form a fluid connection of the cavity 106 to the upper, first partial work space 17. In the arrangement of the adjustment element 102 shown in FIG. 2, the flow openings 72 are clear. In this arrangement, a flow connection is provided from the first partial work space 17 through the cavity 106 in the piston rod 12 into the second partial work space 19.

By a rotating of the adjustment element 102 relative to the piston rod 12, the flow openings 72 are covered in succession. For this, it is advantageous for the flow openings 72 to be arranged at a distance from each other along an outer circumferential direction about the longitudinal axis 7. This means that the individual flow openings 72 are spaced apart from each other in terms of a rotary angle position about the longitudinal axis 7.

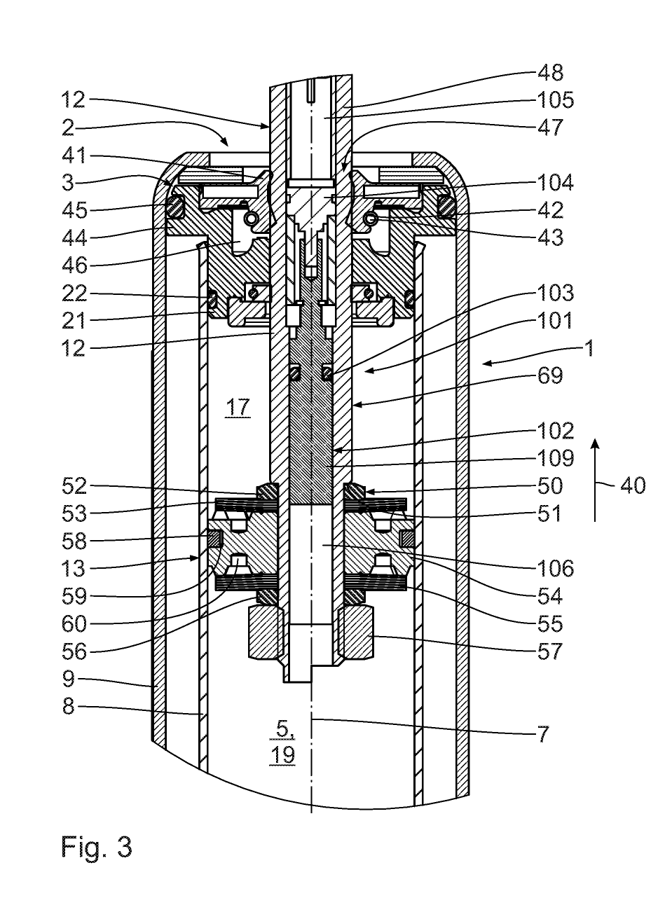

Upon activation of the adjustment actuator 105, the rotary motion is transmitted across the transmission 104 to the adjustment element 102. If a rotary motion is sufficient, the adjustment element 102 as shown in FIG. 3 will come to lie in an arrangement in which the flow openings 72 are closed. In this arrangement, there is no fluid connection between the first partial work space 17 and the second partial work space 19 via the cavity 106 of the piston rod 12. The fluid connection is interrupted in this arrangement.

Depending on the rotary position of the adjustment element 102 with respect to the piston rod 12, more or fewer flow openings 72 or more of less of an overall flow area of the flow channel are opened up. Depending on the size of the effective flow cross section area of the flow channel, the damping action or the damping force of the shock absorber 1 changes. The smaller the effective flow cross section area, the greater the damping force of the shock absorber 1.

In addition or alternatively, a potentiometer can be provided between the transmission 104 and the adjustment element 102 in order to detect directly the absolute position of the adjustment element 102.

The reference travel enables the restoring of an absolute position after a power supply interruption or after an unforeseen loss of position in the control unit. For this, the adjustment element 102 is moved to a reference position, which is defined by the reference element 108.

In the following, the function of the shock absorber 1 shall be described. In the adjusting position of the adjustment element represented in FIGS. 1 and 2, the flow channel 71 in the piston rod 12 is opened to the utmost. Upon movement of the piston 13 against the extending direction 40, the damping fluid 10 can thus flow from the second partial work space 19 through the flow channel 71 in the piston rod 12 into the second partial work space 17. Furthermore, the damping fluid 10 displaced by the additional volume of the piston rod 12 from the work space 5 can flow through the first equalizing channel into the equalizing space 6.

It is provided that the second equalizing channel is closed as much as possible during small forces directed against the extending direction 40 on the piston rod 12, especially during small velocities of the piston 13 against the extending direction 40. In the case of an equalizing valve 31 which enables a bidirectional flow through the second equalizing channel, the equalizing valve 31 is not fully closed. On account of the characteristics, a bidirectional flow through the second equalizing channel is always possible. In theory, however, it is also possible to design the equalizing valve 31 as a one-way valve, which is in a closed position during small forces on the piston rod 12 directed against the extending direction 40. The response behaviour of the equalizing valve 31 is determined by a suitable choice and setup of the valve helical spring and the valve plate spring.

Accordingly, the flow channel 60 in the piston 13 can be closed by the first and/or the second closure element 53, 55 during low velocities of the piston 13.

Upon movement of the piston 13 in the extending direction 40, the damping fluid 10 can flow from the first partial work space 17 through the flow channel 71 in the piston rod 12 into the second partial work space 19. Furthermore, the equalizing valve 31 opens and enables a flow of damping fluid 10 from the equalizing space 6 through the second equalizing channel into the second partial work space 19. In this way, it is ensured that the work space 5 is always entirely filled with damping fluid 10 apart from the volume displaced by the piston mechanism 11.

The equalizing valve 31 in the second closing element and/or the closure elements 53, 55 in the piston 13 may be designed such that, upon movement of the piston rod 12 in the extending direction 40, a flow of damping fluid 10 through the second equalizing channel in the second closing element 24 and/or the flow channel 60 in the piston 13 occurs only during a large extending velocity of the piston rod 12 or a large force on it in the extending direction 40.

The flow channel 60 in the piston 13 and/or the equalizing valve 31 in the second closing element thus act as an overload protection, which is triggered by large velocities and/or forces on the piston rod 12 and thereby prevents a damaging of the shock absorber 1. Of course, the damping behaviour of the shock absorber 1 can be influenced as needed by suitable selection of the closure elements 53, 55 of the flow channel 60 and/or the valve elements of the equalizing valve 31.

By a rotating of the adjustment element 102 about the longitudinal axis 7, the bores 72 of the flow channel 71 in the piston rod 12 can be closed. In this way, the effective flow cross section of the flow channel 71 in the piston rod 12 is decreased, in particular is closed, in particular is closed entirely. A flow of damping fluid 10 from the first partial work space 17 through the flow channel 71 into the second partial work space 19 or vice versa is then no longer possible.

Insofar as the equalizing valve 31 prevents a flow of damping fluid 10 from the second partial work space 19 into the equalizing space 6, the piston rod 12 in this position of the adjustment element 102 is blocked against displacement opposite the extending direction 40 on account of the totally closed volume of the second partial work space 19.

However, if the force on the piston rod 12 in the direction opposite the extending direction 40 exceeds a predetermined limit force, the overload protection is activated and the flow channel 60 in the piston 13 and/or the second equalizing channel in the second closing element is opened.

Since the equalizing valve 31 in the second closing element opens upon movement of the piston 13 in the extending direction 40 in order to allow a flow of damping fluid 10 from the equalizing space 6 into the second partial work space 19, and the first equalizing channel in the first closing element 21 is closed, the shock absorber 1 is not blocked entirely against a movement of the piston rod 12 in the extending direction 40 even in the case of a closed flow channel 71 in the piston rod 12. However, it has a maximum hard damping, since the damping fluid 10 cannot flow through the flow channel 71 in the piston rod 12 from the first partial work space 17 into the second partial work space 19, but rather flows from the first partial work space 17 into the equalizing space 6 and from the equalizing space 6 through the second equalizing channel into the second partial work space 19. Thus, in this case the damping characteristic is determined by the equalizing channels and also in particular by the equalizing valve 31.

In an alternative embodiment it can be provided that the closure elements 53, 55 are designed such that the flow channels 60 in the piston 13 open or close depending on the velocity of movement of the piston rod 12 in the extending direction 40. In this way, a velocity-dependent damping characteristic can be achieved. For details in this regard, reference is made to DE 10 2005 023 756 A1, paragraph [0028] et seq.

In the case of an interruption in the power supply, the position recognition unit 107 ensures a resetting of the position recognition by means of a reference travel. For this, a reference mark is used in particular, which may be designed for example as an end stop element. It is ensured that the position of the adjustment element can be clearly and easily determined and established after an unforeseen interruption in its displacement.

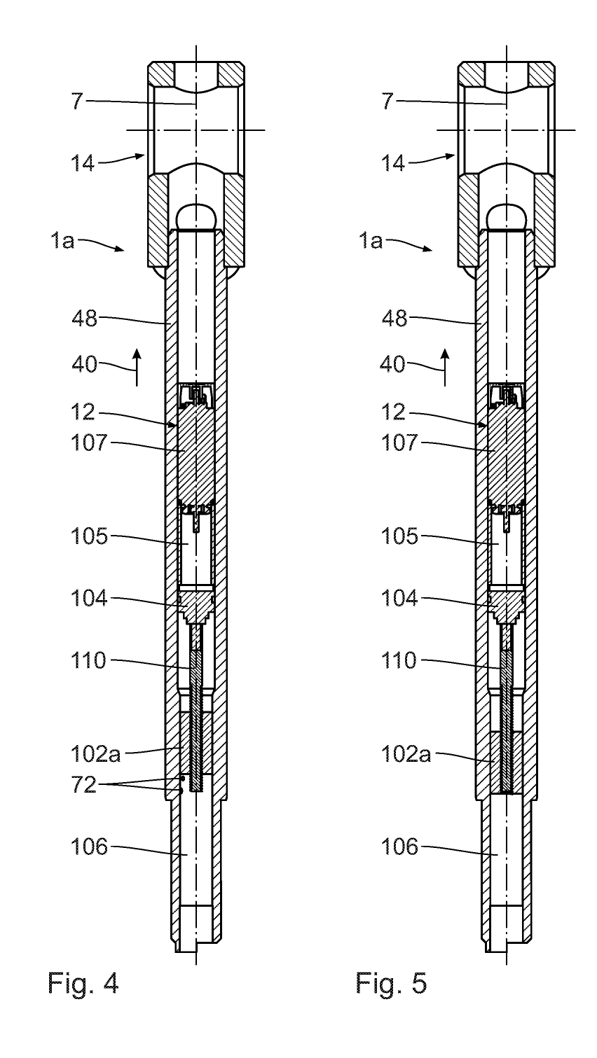

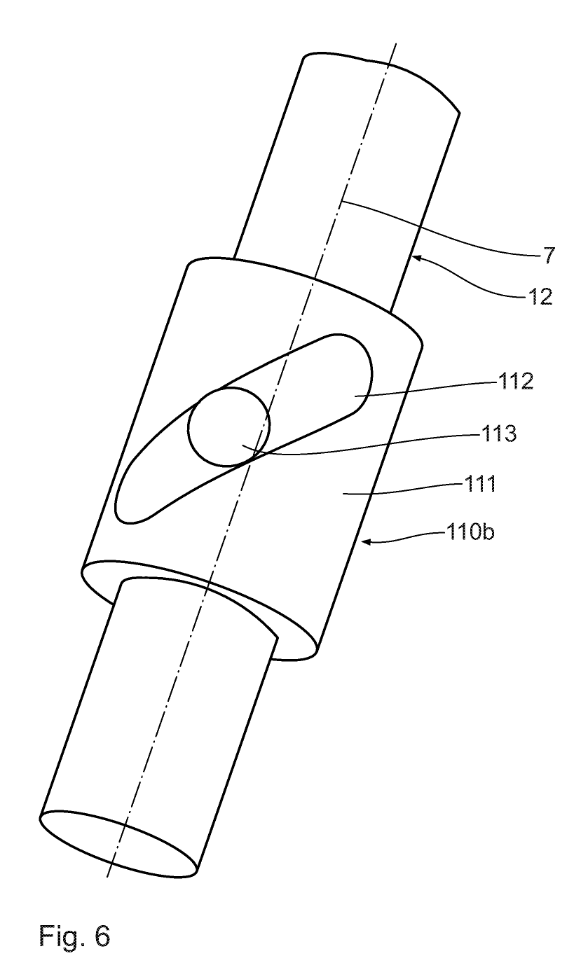

In the following, making reference to FIGS. 4 and 5, a second exemplary embodiment of the invention shall be described. Identical parts are given the same reference numbers as in the first exemplary embodiment, to whose description reference is hereby made. Structurally different, yet functionally identical parts are given the same reference numbers with a suffixed “a”.

In the shock absorber 1a, the adjustment element 102a is designed as a spindle nut, which can be driven by a corresponding displacement spindle 110. The displacement spindle forms a force transmission device, which is coupled directly to the transmission 104. A rotary movement of the displacement spindle 110 produces—depending on the direction of rotation about the longitudinal axis 7—a displacement of the adjustment element 102a along the longitudinal axis 7 in or opposite the extending direction 40.

In the arrangement shown in FIG. 4, some of the flow openings 72 are clear. In the arrangement shown in FIG. 5, in which the spindle nut 102a is arranged further downward, facing the work space 5 of the shock absorber, flow openings 72 are covered. This arrangement corresponds to the arrangement per FIG. 3 of the first exemplary embodiment.

In another embodiment, not shown, the adjustment unit can be designed as a needle valve with a needle movable along the longitudinal axis 7, which can dip into a corresponding valve opening. Depending on the depth of insertion of the valve needle into the valve opening, the effective flow cross section area is changed. It is advantageous for the valve needle and/or the valve opening to have a conical profile at least for a portion along the longitudinal axis 7, so that with increasing depth of insertion of the valve needle into the valve opening the effective flow cross section area is reduced.

In the following, a third exemplary embodiment of the invention shall be described with the aid of FIG. 6. Identical parts are given the same reference numbers as in the first two exemplary embodiments, to whose description reference is hereby made. Structurally different, yet functionally identical parts are given the same reference numbers with a suffixed “b”.

As in the second exemplary embodiment, a kinematic element 110b is provided, which converts a rotary drive movement into an axial displacement of the adjustment element 102b.

The flow openings 72 are arranged at an axial distance from each other especially along the longitudinal axis 7. By an axial displacement of the adjustment element 102a, successively more or fewer flow openings 72 can be covered or opened up.

It is conceivable to provide only a single flow opening, for example in the form of an elongated hole, which can be continuously covered or opened up by means of the adjustment element 102a. This enables a continuous adjusting of the damping force of the shock absorber 1a.

The flow openings 72 are arranged on the piston rod 12 above a radial piston rod end stop 51. The flow openings 72 are coordinated with the first partial work space 17.

The kinematic element 110b is designed as a motion thread, with an outer sleeve 111, having a helical slit guide 112. In the slit guide 112 there is arranged a cross-bolt 113, which is oriented transversely to the longitudinal axis 7. The cross-bolt 113 is connected firm against rotation to an inner displacement element, not otherwise shown. Upon rotary drive movement of the adjustment actuator and the adjustment element, the latter is force-guided by means of the cross-bolt 113 in the guide slit 112 and moved upward or downward along the longitudinal axis 7, depending on the direction of rotation.

What is claimed is:

1. A shock absorber comprising
a. a housing (8) having a work space (5),
b. damping fluid (10) present in the work space (5),
c. a piston unit (11) arranged in the work space (5) with
i. a piston rod (12) having a longitudinal axis (7),
ii. a piston (13) secured to the piston rod (12), dividing the work space (5) into a first partial work space (17) and a second partial work space (19),
iii. a flow channel (71) connecting the first partial work space (17) and the second partial work space (19),
d. an adjustment unit (101) for adjusting the damping force of the shock absorber (1) with
i. an adjustment element (102) for adjusting the effective flow cross section area of the flow channel (71),
ii. an adjustment actuator (105) for the automated adjusting of an arrangement of the adjustment element (102) and the piston rod (12),
wherein the adjustment unit (101) is arranged inside the shock absorber (1).

2. A shock absorber according to claim 1, comprising a control unit, which stands in signal communication with the adjustment unit (101) for the specific adjusting of the effective flow cross section area of the flow channel (71).

3. A shock absorber according to claim 1, wherein the adjustment element (102) and the piston rod (12) are rotatable relative to each other in regard to the longitudinal axis (7).

4. A shock absorber according to claim 1, wherein the adjustment element (102) is rotatable in regard to the longitudinal axis (7).

5. A shock absorber according to claim 4, wherein the adjustment element (102) is designed as a shaft shoulder, which has a step along the longitudinal axis (7), wherein at least one step of the shaft shoulder has a non-round cross section area oriented perpendicular to the longitudinal axis (7).

6. A shock absorber according to claim 4, wherein the adjustment element (102) is designed as a shaft shoulder, which has multiple steps along the longitudinal axis (7), wherein at least one step of the shaft shoulder has a non-round cross section area oriented perpendicular to the longitudinal axis (7).

7. A shock absorber according to claim 1, wherein the adjustment element (102) is axially movable with regard to the longitudinal axis (7).

8. A shock absorber according to claim 7, wherein the adjustment element (102) is designed as a spindle nut.

9. A shock absorber according to claim 7, wherein the adjustment unit (101) is designed as a needle valve.

10. A shock absorber according to claim 1, wherein the adjustment unit (101) is arranged integrated in the piston rod (12).

11. A shock absorber according to claim 1, wherein the piston rod (12) is tubular in design.

12. A shock absorber according to claim 1, comprising a position recognition unit (107).

13. A shock absorber according to claim 12, wherein the recognition unit (107) stands in signal communication with the adjustment unit (101).

14. A shock absorber according to claim 12, wherein the recognition unit (107) stands in signal communication with the adjustment actuator (105).

15. A shock absorber according to claim 1, comprising a reference element (108) for defining a reference position of the adjustment element (102).

16. A shock absorber according to claim 1, wherein the adjustment actuator (105) is designed as a rotary drive.

17. A shock absorber according to claim 1, wherein the adjustment actuator (105) is designed as an electric motor.

18. A shock absorber according to claim 1, comprising a sealing element (103) for sealing off a cavity (106) of the piston rod (12).
